(19) United States
(12) Patent Application Publication
(10) Pub. No.: US 2002/0012781 A1
(43) Pub. Date: Jan. 31, 2002

(54) MONO-OR MULTILAYER FILM

(76) Inventors: EKKEHARD BEER, BAD SCHWALBACH (DE); WILFRIED HATKE, HOFHEIM (DE)

Correspondence Address: FROMMER LAWRENCE & HAUG, 745 FIFTH AVENUE, NEW YORK, NY, 10151, US

(21) Appl. No.: 08/957,187

(22) Filed: Oct. 24, 1997

(30) Foreign Application Priority Data
Oct. 28, 1996 (DE) 19644675.9
Jun. 19, 1997 (DE) 19725975.8

(51) Int. Cl. B32B 27/32

(52) U.S. Cl. 428/220; 428/516; 428/518; 428/519; 428/521; 428/523

(57) ABSTRACT

The present invention relates to a mono- or multilayer film, where the film consists of a cycloolefin copolymer or mixtures of cycloolefin copolymers and one or more thermoplastics, and where, at 85% relative humidity and a temperature of about 23° C., the film has a water vapor permeation of ≦0.035 g*mm/m²d, a puncture resistance of ≦300 N/mm and a thickness of ≦100 μm.

The present invention relates to a mono- or multilayer film which is for use as backing film for blister packs and which is easy to process, has good barrier properties, especially with respect to water vapor, is easy to recycle and permits easy handling by the final user.

Blister packs are chosen increasingly frequently as packaging for a very wide range of objects, since this form of packaging gives a wide variety of design possibilities and is adaptable for mechanized packaging. The starting material for a blister pack is a thermoformable film. Such films are plastic films which, by heating, are brought to a condition in which they are comparatively easy to form, using pneumatic superatmospheric or subatmospheric pressure or by means of a male mold. Suitably selected molds can introduce depressions (blisters) into the film (base film) which can be matched to the shape of the object to be packaged. After this forming step, the object to be packaged is introduced into the resultant blister. After the blister has been filled, a backing film is applied to the base film and encloses the object to be packaged within its blister. By selecting a transparent base film, it is possible to achieve optimum presentation of the packaged object. It is possible to place product information on the outer side of the backing film.

The most frequently used combination for packaging pharmaceuticals in blister packs is polyvinyl chloride (PVC) as base film and aluminum film as backing film. In order to increase its barrier effect with respect to gases, in particular water vapor, the PVC base film is frequently coated with PVDC. Attempts have been made over a number of years to replace the PVC base film by other materials, in order to avoid environmental pollution (evolution of hydrogen chloride) which arises during the incineration of PVC. Base films made from polypropylene (PP) are better than PVC films as barriers with respect to water vapor and pose fewer ecological risks. Their disadvantage, however, is poorer thermoformability and higher shrinkage.

At present, the backing film of blister packs for pharmaceutical products is almost exclusively aluminum film. Adhesion to the base film, usually PVC, is achieved by precoating the aluminum film with an adhesive system in the form of a heat-sealing lacquer. However, blister packs constructed on the principle of a plastic base film and an aluminum backing film have the disadvantage of being difficult to recycle or to dispose of in a rational manner.

A blister pack having polypropylene film as backing film and base film has been described as prior art, cf. DE-A-4414669. This system is significantly easier to recycle than, for example, PVC with aluminum as backing film. However, difficulties arise in processing, especially of the base film on available blister pack machines. For this reason, blister packs based on polypropylene films have hitherto not been widely used.

Relatively new developments in the field of blister packs for pharmaceuticals have demonstrated the use of amorphous polyolefins, which have good processing performance and are effective barriers with respect to water vapor. Thus, EP-A-570 188 and EP-A-631 864 describe the use of polyolefins having cyclic olefins as polymer building blocks. Because of their amorphous nature, films produced from these polymers are significantly easier to thermoform than partially crystalline materials, such as polypropylene.

Besides automated packaging and presentation of the product protected in the blister, blister packs can fulfill other functions, if base films and backing films having particular properties are selected. For the packaging of sensitive pharmaceutical products in the form of tablets, capsules or the like, the selection of suitable base films and backing films allows a significant reduction in the influence of atmospheric moisture and oxygen and thus increases shelf life. In this application, a wide variety of requirements are placed on the base film and the backing film. Besides the barrier properties required, the base film must also have very good thermoformability, permitting effective shaping of the blisters with very uniform wall thickness and high thermoforming speeds. In order to ensure secure closure of the individual blisters, base film and backing films must adhere well to each other. The backing film should likewise provide an effective barrier, especially with respect to atmospheric moisture (water vapor) and should be printable, so that information can be applied thereto. The backing film must be easy to puncture, in order to ensure that the pharmaceutical products can be removed simply by pressure on the blister. For particular applications, the backing film must also be easy to pull off.

The backing film should be as effective a barrier as the base film, in order to give very good exclusion of water vapor and other gases. The requirement here is that the backing film should be as effective a barrier with respect to water vapor as the thermoformed base film blister. This can be achieved by using a material whose barrier effectiveness is significantly higher. It then becomes possible to use this material in a thickness which is significantly less than that of the base film of the blister. If a material is used which is a comparable barrier, then the thickness of the backing film must be correspondingly adjusted. The backing film should preferably be easy to puncture, so that it is possible to remove the solid pharmaceutical products simply by pressure on the thermoformed blister. The backing film should have sufficient mechanical stability for it to be easy to process without difficulty on the blister pack machines used.

The object of the present invention is to provide a mono- or multilayer film for a backing film in a blister pack, which film is easy to process, has good barrier properties, especially with respect to water vapor, is easy to recycle and permits easy handling by the processor and final user.

The object of the present invention is achieved by means of a mono- or multilayer film which comprises at least one layer of a cycloolefin polymer or of a mixture of cycloolefin polymers with one or more thermoplastics, where the mono- or multilayer film preferably has, at a relative moisture of approximately 85% and a temperature of approximately 23° C., a water vapor permeation of ≦0.035 g*mM/M²d, a puncture resistance of ≦300 N/mm and a thickness of ≦100 μm.

A film which is particularly suitable for the purposes of the invention comprises at least one cycloolefin copolymer selected from the class consisting of polymers comprising from 0.1 to 100% by weight, preferably from 0.1 to 99.9% by weight, based on the total weight of the cycloolefin polymer, of polymerized units of at least one cyclic olefin of the formulae I, II, II′, III, IV, V or VI

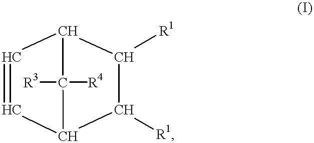

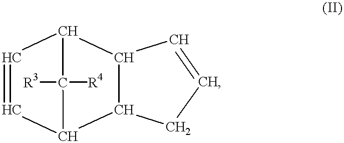

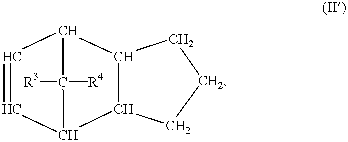

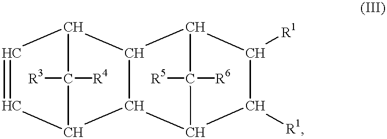

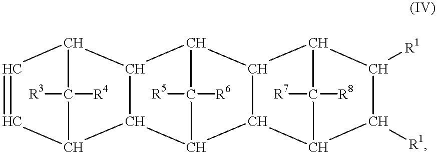

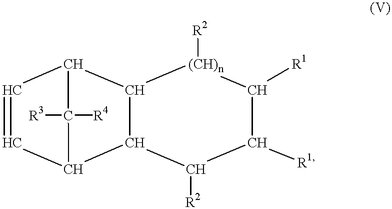

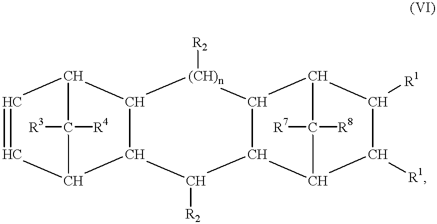

where R¹, R², R³, R⁴, R⁵, R⁶, R⁷ and R⁸ are identical or different and are hydrogen or a C₁-C₂₀-hydrocarbon radical, such as a linear or branched C₁-C₈-alkyl radical, C₆-C₁₈-aryl radical, C₇-C₂₀-alkylenearyl radical, a cyclic or acyclic C₂-C₂₀-alkenyl radical or form a saturated, unsaturated or aromatic ring, where the same radicals R¹ to R⁸ may be different in the different formulae I to VI, where n is from 0 to 5, and from 0 to 99 mol %, based on the entire structure of the cycloolefin copolymer, of polymerized units derived from one or more acyclic olefins of the formula VII

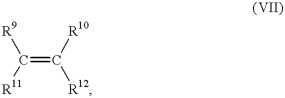

where R⁹, R¹⁰, R¹¹ and R¹² are identical or different and are hydrogen, a linear or branched, saturated or unsaturated C₁-C₂₀-hydrocarbon radical, such as a C₁-C₈-alkyl radical or a C₆-C₁₈-aryl radical.

The cycloolefin polymers may also be obtained by ring-opening polymerization of at least one of the monomers having the formulae I to VI, followed by hydrogenation of the resultant products.

The cycloolefin copolymer according to the invention may moreover contain from 0 to 45 mol %, based on the entire structure of the cycloolefin copolymer, of polymerized units derived from one or more monocyclic olefins of the formula VII

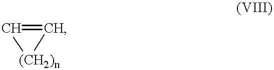

where n is a number from 2 to 10.

The proportion of polymerized units derived from cyclic, in particular polycyclic, olefins is preferably from 3 to 75 mol %, based on the entire structure of the cycloolefin copolymer. The proportion of polymerized units derived from acyclic olefins is preferably from 5 to 80 mol %, based on the entire structure of the cycloolefin copolymer.

The cycloolefin copolymers preferably consist of polymerized units derived from one or more polycyclic olefins, in particular from polycyclic olefins of the formulae I or III, and of polymerized units derived from one or more acyclic olefins of the formula VII, in particular α-olefins having from 2 to 20 carbon atoms. Preference is particularly given to cycloolefin copolymers which consist of polymerized units derived from a polycyclic olefin of the formula I or III and from an acyclic olefin of the formula VII. Preference is furthermore given to terpolymers which consist of polymerized units derived from a polycyclic monoolefin of the formula I or III, from an acyclic monoolefin of the formula VII and from a cyclic or acyclic olefin (polyene) which contains at least two double bonds, in particular cyclic, preferably polycyclic, dienes, such as norbornadiene or cyclic, particularly preferably polycyclic, alkenes, such as vinylnorbornene, which carry a C₂-C₂₀-alkenyl radical.

The cycloolefin polymers according to the invention preferably comprise olefins based on a norbornene structure, particularly preferably norbornene, tetracyclododecene and, if desired, vinylnorbornene or norbornadiene. Preference is also given to cycloolefin copolymers which comprise polymerized units derived from acyclic olefins having terminal double bonds, such as α-olefins having from 2 to 20 carbon atoms, particularly preferably ethylene or propylene. Particular preference is given to norbornene-ethylene copolymers and tetracyclododecene-ethylene copolymers.

Among the terpolymers, particular preference is given to norbornene-vinylnorbornene-ethylene terpolymers, norbornene-norbornadiene-ethylene terpolymers, tetracyclododecene-vinylnorbornene-ethylene terpolymers and tetracyclododecene-vinyltetracyclododecene-ethylene terpolymers. The proportion of the polymerized units derived from a polyene, preferably vinylnorbornene or norbornadiene, is from 0.1 to 50 mol %, particularly preferably from 0.1 to 20 mol %, and the proportion of the acyclic monoolefin of the formula VII is from 0 to 99 mol %, preferably from 5 to 80 mol %, based on the entire structure of the cycloolefin copolymer. In the terpolymers described, the proportion of the polycyclic monoolefin is from 0.1 to 99 mol %, preferably from 3 to 75 mol %, based on the entire structure of the cycloolefin copolymer.

The cycloolefin copolymer according to the invention preferably comprises at least one cycloolefin copolymer which comprises polymerized units which can be derived from polycyclic olefins of the formula I and polymerized units which can be derived from acyclic olefins of the formula VII.

The cycloolefin polymers according to the invention may be prepared at temperatures from −78 to 200° C. and at a pressure of from 0.01 to 200 bar in the presence of one or more catalyst systems which comprise at least one transition metal compound and, if desired, a cocatalyst and, if desired, a supporting material. Suitable transition metal compounds are metallocenes, in particular stereorigid metallocenes. Examples of catalyst systems which are suitable for preparing the cycloolefin polymers according to the invention are described in EP-A-407 870, EP-A-485 893 and EP-A-503 422, which are expressly incorporated herein by way of reference.

Examples of transition metal compounds used are:

rac-dimethylsilylbis(1-indenyl)zirconium dichloride,

rac-dimethylgermylbis(1-indenyl)zirconium dichloride,

rac-phenylmethylsilylbis(1-indenyl)zirconium dichloride,

rac-phenylvinylsilylbis(1-indenyl)zirconium dichloride,

1-silacyclobutylbis(1-indenyl)zirconium dichloride,

rac-diphenylsilylbis(1-indenyl)hafnium dichloride,

rac-phenylmethylsilylbis(1-indenyl)hafnium dichloride,

rac-diphenylsilylbis(1-indenyl)zirconium dichloride,

rac-ethylene-1,2-bis(1-indenyl)zirconium dichloride,

dimethylsilyl-(9-fluorenyl)(cyclopentadienyl)zirconium dichloride,

diphenylsilyl-(9-fluorenyl)(cyclopentadienyl)zirconium dichloride,

bis(1-indenyl)zirconium dichloride,

diphenylmethylene-(9-fluorenyl)cyclopentadienylzirconium dichloride,

isopropylene-(9-fluorenyl)cyclopentadienylzirconium dichloride,

rac-isopropylidenebis(1-indenyl)zirconium dichloride,

phenylmethylmethylene-(9-fluorenyl)cyclopentadienylzirconium dichloride,

isopropylene-(9-fluorenyl)(1-(3-isopropyl)cyclopentadienyl)zirconium dichloride,

isopropylene-(9-fluorenyl)(1-(3-methyl)cyclopentadienyl)zirconium dichloride,

diphenylmethylene-(9-fluorenyl)(1-(3-methyl)cyclopentadienyl)zirconium dichloride,

methylphenylmethylene-(9-fluorenyl)(1-(3-methyl)cyclopentadienyl)-zirconium dichloride,

dimethylsilyl-(9-fluorenyl)(1-(3-methyl)cyclopentadienyl)zirconium dichloride,

diphenylsilyl-(9-fluorenyl)(1-(3-methyl)cyclopentadienyl)zirconium dichloride,

diphenylmethylene-(9-fluorenyl)(1-(3-tert-butyl)cyclopentadienyl)zirconium dichloride,

isopropylene-(9-fluorenyl)(1-(3-tert-butyl)cyclopentadienyl)zirconium dichloride,

isopropylene(cyclopentadienyl)(1-indenyl)zirconium dichloride,

diphenylcarbonyl(cyclopentadienyl)(1-indenyl)zirconium dichloride,

dimethylsilyi(cyclopentadienyl)(1-indenyl)zirconium dichloride, isopropylene(methylcyclopentadienyl)(1-indenyl)zirconium dichloride,

4-(η⁵-cyclopentadienyl)-4,7,7-trimethyl(η⁵-4,5,6,7-tetrahydroindenyl-zirconium dichloride,

[4-(η⁵-cyclopentadienyl)-4,7,7-triphenyl-(η⁵-4,5,6,7-tetrahydroindenyl)]zirconium dichloride,

[4-(η⁵-cyclopentadienyl)-4,7-dimethyl-7-phenyl-(η⁵-4,5,6,7-tetrahydroindenyl)]zirconium dichloride,

[4-(η⁵-3′-tert-butylcyclopentadienyl)-4,7,7-triphenyl-(η⁵-4,5,6,7-tetrahydroindenyl)]zirconium dichloride,

[4-(η⁵-3′-tert-butylcyclopentadienyl)-4,7-dimethyl-7-phenyl-(η⁵-4,5,6,7-tetrahydroindenyl)]zirconium dichloride,

[4-(η⁵-3′-methylcyclopentadienyl)-4,7,7-trimethyl-(η⁵-4,5,6,7-tetrahydroindenyl)]zirconium dichloride,

[4-(η⁵-3′-methylcyclopentadienyl)-4,7,7-triphenyl-(η⁵-4,5,6,7-tetrahydroindenyl)]zirconium dichloride,

[4-(η⁵-3′-methylcyclopentadienyl)-4,7-dimethyl-7-phenyl-(η⁵-4,5,6,7-tetrahydroindenyl)]zirconium dichloride,

[4-(η⁵-3′-isopropylcyclopentadienyl)-4,7,7-trimethyl-(η⁵-4,5,6,7-tetrahydroindenyl)]zirconium dichloride,

[4-(θ⁵-3′-isopropylcyclopentadienyl)-4,7,7-triphenyl-(η⁵-4,5,6,7-tetrahydroindenyl)]zirconium dichloride,

[4-(η⁵-3′-isopropylcyclopentadienyl)-4,7-dimethyl-7-phenyl-(η⁵-4,5,6,7-tetrahydroindenyl)]zirconium dichloride,

[4-(η⁵-cyclopentadienyl)(η⁵-4,5-tetrahydropentalene)]zirconium dichloride,

[4-(η⁵-cyclopentadienyl)-4-methyl(η⁵-4,5-tetrahydropentalene)]zirconium dichloride,

[4-(η⁵-cyclopentadienyl)-4-phenyl(η⁵-4,5-tetrahydropentalene)]zirconium dichloride,

[4-(η⁵-cyclopentadienyl)-4-phenyl(η⁵-4,5-tetrahydropentalene)]zirconium dichloride,

[4-(η⁵-3′-methylcyclopentadienyl)(η⁵-4,5-tetrahydropentalene)]zirconium dichloride,

[4-(η⁵-3′-isopropylcyclopentadienyl)(η⁵-4,5-tetrahydropentalene)]zirconium dichloride,

[4-(η⁵-3′-benzylcyclopentadienyl)(η⁵-4,5-tetrahydropentalene)]zirconium dichloride,

[2,2,4-trimethyl-4-(η⁵-cyclopentadienyl)(η⁵-4,5-tetrahydropentalene)]-zirconium dichloride,

[2,2,4-trimethyl-4-(η⁵-(3,4-diisopropyl)cyclopentadienyl)(η⁵-4,5-tetrahydropentalene)]zirconium dichloride.

The COC films used according to the invention have specific mechanical properties. The films can be processed on the machines which are in use, and at the same time have low puncture resistance and are effective barriers, particularly with respect to water vapor. These COC films are suitably oriented. They may be mono- or multilayer films. The films may contain organic or inorganic fillers to reduce their translucency or to improve their printability.

The preparation of the cycloolefin polymers is carried out using heterogeneous or homogeneous catalysis with organometallic compounds and is described in many patents. Catalyst systems based on mixed catalysts of titanium salts and organoaluminum compounds are described in DD-A-109 224 and DD-A-237 070. EP-A-156 464 describes the preparation using vanadium-based catalysts. EP-A-283 164, EP-A-407 870, EP-A-485 893 and EP-A-503 422 describe the preparation of cycloolefin polymers using catalysts based on soluble metallocene complexes. The preparation processes described and the catalyst systems used in these patents for preparing COC are hereby expressly incorporated herein by way of reference.

An important requirement of backing films is reliable handling on the machines which are used. Non-oriented extruded COC films are brittle, conditions for their further processing are rendered difficult and results are only very poor, cf. DE-A-4304309. During winding or unwinding under tension, they tend to tear or break easily. Because of this, their mechanical strength has to be increased. This can be achieved by orientation (mono- or biaxial orientation) of the films. Films oriented in this way have significantly better processability, without the disadvantages described, cf. DE-A-4304309. The puncture resistance of oriented films was tested to DIN 53373. The penetration energy may be taken as a measure of the puncture resistance. It has now been found that the puncture resistance of the films increases with orientation. The values measured were higher than those of non-oriented films of comparable thickness. According to DE-A-4414669, a puncture resistance of 450 N/mm is too high for backing films in blister packs. For delicate pharmaceutical products, lower values are desirable. The puncture resistance of aluminum films may be taken as a preliminary guide, and for an aluminum film (16 μm), this is 90 N/mm. Biaxially oriented COC films have puncture resistances greater than 450 N/mm. Such films cannot therefore be used as backing films for blister packs.

Because the COC base film and the backing film have similar action as water vapor barriers, the thickness of the backing film cannot be reduced at will in order to adjust its puncture resistance. This implies a thickness for COC-based backing films in the range from 20 to 150 μm.

Surprisingly, it has now been found that COC films which have been given a very specific orientation can be processed without the disadvantages described and have a relatively low puncture resistance. The puncture resistance is comparable with that of aluminum films which are used as backing films for blister packs. The important point here is that the orientation conditions are selected so that the puncture resistance is in the range from 50 to 400 N/mm, preferably in the range from 80 to 300 N/mm. To ensure reliable processing, the film must have sufficiently high mechanical strength in the machine direction. This implies an elongation at break of the film of >3% and a tear strength of >40 MPa.

The effectiveness of this film as a water vapor barrier is comparable with values observed for unoriented COC films. The orientation therefore has no marked influence on the effectiveness of the films as barriers. The thicknesses of backing films based on COC films should therefore be within the range of the thicknesses of the films in the thermoformed blister. This gives film thicknesses for the backing films in the range from 20 to 150 μm, preferably from 40 to 100 μm.

The effectiveness as water vapor barrier is not significantly influenced by addition of organic or inorganic additives. It is in the range from 0.2 to 0.4 g/m²*d for a film thickness of 100 μm (23° C., 85% relative humidity). Using additives, it is possible to produce pigmented or opaquely white or colored films. By this means, it is possible to provide color characterization of pharmaceutical product packs, increase opacity for light-sensitive pharmaceutical products or improve the printability of the films. The printability of COC backing films may be improved by using suitable methods to increase the polarity of the surface. This can be achieved by corona treatment of the film. The additives may be organic polymers, such as polypropylene or polyethylene in the form of homo- or copolymers, polyesters, polyamides, polycarbonate, polyacetals and acrylate and methacrylate polymers. Inorganic pigments which may be used are titanium dioxide, barium sulfate, calcium sulfate, calcium carbonate and barium carbonate. To improve adhesion to base films of thermoplastic polymers, heat-sealable coatings may be applied to the novel backing films. The heat-sealable coatings must be adapted to the type of base film used. Examples of materials for heat-sealable coatings are ethylene polymers and propylene polymers having, in each case, different proportions of polar groups, such as those obtained by copolymerization with, inter alia, vinyl acetate or acrylate monomers, and polymers based on copolymers of ethylene or propylene with alpha-olefins and polar monomers. The heat-sealable coatings used may also be copolymers of ethylene or propylene which are grafted with, inter alia, maleic anhydride. The choice of heat-sealable coatings can be used to adjust the heat-sealing temperatures within a wide range.

The invention will be described in more detail using examples.

### EXAMPLES

### Example 1

A non-oriented film of thickness 80 μm was produced from a copolymer of ethylene and 2-norbornene prepared using a metallocene catalyst and having a ethylene content (¹³C-NMR) of 45 mol %, a glass transition temperature (DSC, 20° C./min, midpoint) of 140° C., a solution viscosity (0.5% strength by weight solution in decalin at 135° C.) of 58 ml/g and a molecular weight M_{w}: 42000 g/mol and Mₙ: 19500 g/mol (GPC, polyethylene standards, o-dichlorobenzene, T=135° C.). The film was very brittle and fractured easily. The mechanical properties of this film were as follows: (mean values from three measurements):

| Property | |
|---|---|
| Thickness (μm) | 30 |
| Modulus of elasticity (MPa) | 2350 |
| Tear strength (MPa) | 60 |
| Elongation at break (%) | 2 |
| Puncture resistance (N/mm) | 60 |

### Example 2

A non-oriented film of thickness 300 μm was produced from the polymer described in Example 1. Squares of 20 cm edge length were cut out from the film and clamped in a stretching frame. After preheating for 5 minutes at a temperature of 150° C., the film was simultaneously biaxially stretched by a factor of 3. Following the stretching, the edges (about 5 cm) were removed. The resultant film had the following properties (mean values from three measurements):

| Property | |
|---|---|
| Thickness (μm) | 30 |
| Modulus of elasticity (MPa) | 3350 |
| Tear strength (MPa) | 92 |
| Elongation at break (%) | 45 |
| Puncture resistance (N/mm) | 550 |

### Example 3

A non-oriented film of thickness 100 μm was produced from the polymer described in Example 1. Squares of 20 cm edge length were cut out from the film and clamped in a stretching frame. After preheating for 5 minutes at a temperature of 150° C., the film was simultaneously stretched by a factor of 1.2 in one direction and by a factor of 3.0 in the other direction. Following the stretching, the edges (about 5 cm) were removed. The resultant film had the following properties (mean values from three measurements):

| | Stretch factor: | Stretch factor: |
|---|---|---|
| Property | 1.2 | 3.0 |
| Thickness (μm) | 30 | 30 |
| Modulus of elasticity (MPa) | 2500 | 3600 |
| Tear strength (MPa) | 55 | 95 |
| Elongation at break (%) | 2 | 30 |
| Puncture resistance (N/mm) | 120 | 120 |

### Example 4

A non-oriented film of thickness 200 μm was produced by extrusion from a copolymer of ethylene and 2-norbornene prepared using a metallocene catalyst and having a ethylene content (¹³C-NMR) of 55 mol %, a glass transition temperature (DSC, 20° C./min, midpoint) of 80° C., a solution viscosity (0.5% strength by weight solution in decalin at 135° C.) of 80 ml/g and a molecular weight M_{w}: 52000 g/mol and Mₙ: 24500 g/mol (GPC, polyethylene standards, o-dichlorobenzene, T=135° C.). The film was very brittle and fractured easily. The mechanical properties of this film were as follows:

| Property | | |
|---|---|---|
| Thickness: | 200 | μm |
| Modulus of elasticity: | 2050 | MPa |
| Tear strength: | 65 | MPa |
| Elongation at break: | 3-4% | |
| Puncture resistance: | 200 | N/mm |

### Examples 5-7

A non-oriented film of thickness 200 μm was produced by extrusion from the polymer described in Example 4. Squares of 20 cm edge length were cut out from the film and clamped in a stretching frame. After preheating for 5 minutes at a temperature of 90° C., the film was stretched in one direction by various factors. Following the stretching, the edges (about 5 cm) were removed. The resultant film had the following properties:

| Properties in | | | | | | |
|---|---|---|---|---|---|---|
| direction of | Stretch factor | | Stretch factor | | Stretch factor | |
| stretching | 1.1 (5) | | 1.4 (6) | | 2.0 (7) | |
| Thickness: | 185 | μm | 145 | μm | 128 | μm |
| Modulus of elasticity: | 2500 | MPa | 3600 | MPa | 3600 | MPa |
| Tear strength: | 55 | MPa | 95 | MPa | 95 | MPa |
| Elongation at break: | 2% | | 45% | | 45% | |
| Puncture resistance: | 210 | N/mm | 245 | N/mm | 290 | N/mm |

### Examples 8-10

A non-oriented film of thickness 200 μm was produced by extrusion from a mixture of 75% (w/w) of the polymer described in Example 4 and 25% (w/w) of a polypropylene homopolymer (Tm: 160° C., MFI (230/2.16): 9 ml/10 min). Squares of 20 cm edge length were cut out from the film and clamped in a stretching frame. After preheating for 5 minutes at a temperature of 100° C., the film was stretched in one direction by various factors. Following the stretching, the edges (about 5 cm) were removed. The resultant film had the following properties:

| Properties in | | | | | | |
|---|---|---|---|---|---|---|
| direction of | Stretch factor | | Stretch factor | | Stretch factor | |
| stretching | 2.0 (8) | | 2.9 (9) | | 3.5 (10) | |
| Thickness: | 114 | μm | 145 | μm | 128 | μm |
| Modulus of elasticity: | 2350 | MPa | 2450 | MPa | 2600 | MPa |
| Tear strength: | 110 | MPa | 115 | MPa | 120 | MPa |
| Elongation at break: | 70% | | 90% | | 110% | |
| Puncture resistance: | 300 | N/mm | — | N/mm | 1100 | N/mm |

The properties of these films at right angles to the direction of stretching were: Elongation at break: 3-4%, Modulus of elasticity: 2050- 2100 MPa, Tear strength: 40-45 MPa.

### Example 11

The effectiveness of the films from Examples 4, 7 and 8 as barriers to water vapor were determined at 23° C. and 85% relative humidity. The results are shown in the following table.

| | Water vapor permeation |
|---|---|
| Film | (g*100 μm/m²*d) |
| No. 4 | 0.27 |
| No. 7 | 0.28 |
| No. 8 | 0.28 |

1. A mono- or multilayer film comprising at least one layer of a cycloolefin polymer or of a mixture of cycloolefin polymers with one or more thermoplastics, where the mono- or multilayer film has, at a relative humidity of approximately 85% and a temperature of approximately 23° C., a water vapor permeation of ≦0.035 g*mm/m²d, a puncture resistance of ≦300 n/mm and a thickness of ≦100 μm.

2. A mono- or multilayer film as claimed in claim 1, where the mono- or multilayer film comprises at least one cycloolefin polymer selected from the class of polymers comprising from 0.1 to 100% by weight, preferably from 0.1 to 99.9% by weight, based on the total weight of the cycloolefin polymer, of polymerized units of at least one cyclic olefin of the formulae I, II, II′, III, IV, V or VI 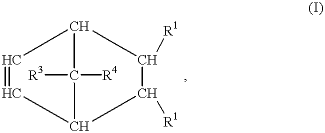 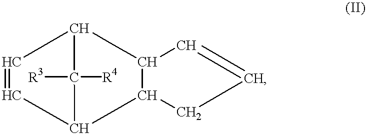 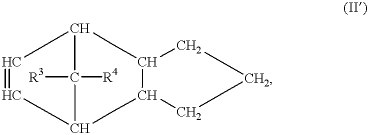 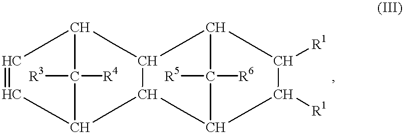 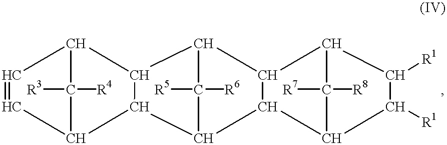 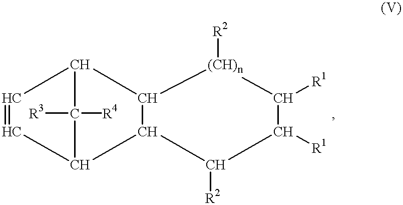 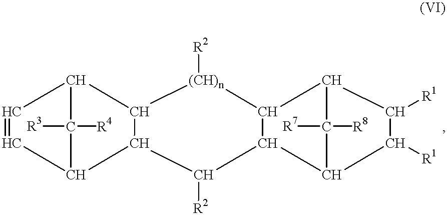
where R¹, R², R³, R⁴, R⁵, R⁶, R⁷ and R⁸ are identical or different and are hydrogen or a C₁-C₂₀-hydrocarbon radical, such as a linear or branched C₁-C₈-alkyl radical, C₆-C₁₈-aryl radical, C₇-C₂₀-alkylenearyl radical, a cyclic or acyclic C₂-C₂₀-alkenyl radical or form a saturated, unsaturated or aromatic ring, where the same radicals R¹ to R⁸ may be different in the different formulae I to VI, where n is from 0 to 5, and from 0 to 99 mol %, based on the entire structure of the cycloolefin copolymer, of polymerized units derived from one or more acyclic olefins of the formula VII 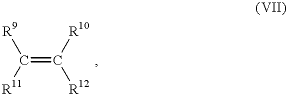
where R⁹, R¹⁰, R¹¹ and R¹² are identical or different and are hydrogen, a linear or branched, saturated or unsaturated C₁-C₂₀-hydrocarbon radical, such as a C₁-C₈-alkyl radical or a C₆-C₁₈-aryl radical.

3. A mono- or multilayer film as claimed in claim 1, where the mono- or multilayer film comprises at least one cycloolefin polymer which is obtained by ring-opening polymerization of at least one of the monomers having the formulae I to VI, followed by hydrogenation of the resultant products.

4. A mono- or multilayer film as claimed in one or more of claims 1 to 3, where the mono- or multilayer film comprises at least one cycloolefin polymer which contains from 0 to 45 mol %, based on the entire structure of the cycloolefin copolymer, of polymerized units derived from one or more monocyclic olefins of the formula VIII 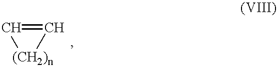
where n is a number from 2 to 10.

5. A mono- or multilayer film as claimed in one or more of claims 1 to 4, where the mono- or multilayer film is monoaxially oriented and has a stretching ratio of from 1.1 to 4.0.

6. A mono- or multilayer film as claimed in one or more of claims 1 to 5, where the mono- or multilayer film contains one or more of the inorganic fillers titanium dioxide, barium sulfate, calcium sulfate, calcium carbonate and barium carbonate.

7. The use of a mono- or multilayer film as claimed in one or more of claims 1 to 6 as backing film for blister packs.

8. The use of a blister pack as claimed in claim 7 for storing and transporting pharmaceutical products, particularly dry oral preparations.
